(19) United States
(12) Patent Application Publication
(10) Pub. No.: US 2024/0033713 A1
(43) Pub. Date: Feb. 1, 2024

(54) POROUS MICROSPHERES AND STATIONARY PHASE MEDIUM AND CHROMATOGRAPHIC COLUMN COMPRISING SAME

(71) Applicant: Tantti Laboratory Inc., Taoyuan City (TW)

(72) Inventors: Hui CHEN, Taoyuan City (TW); Min-Shyan SHEU, Taoyuan City (TW); Tsung-Han TU, Taoyuan City (TW); Jih-Hsien LEE, Taoyuan City (TW); Bruce C.S. CHOU, Taoyuan City (TW)

(21) Appl. No.: 18/225,732

(22) Filed: Jul. 25, 2023

Related U.S. Application Data
(60) Provisional application No. 63/392,939, filed on Jul. 28, 2022.

(30) Foreign Application Priority Data
May 24, 2023 (TW) 112119389

(51) Int. Cl. B01J 20/28; B01J 20/26; B01J 20/30; B01J 20/285; B01D 15/26

(52) U.S. Cl. CPC B01J 20/28085; B01J 20/28042; B01J 20/261; B01J 20/3085; B01J 20/28052; B01J 20/28095; B01J 20/285; B01D 15/265; B01J 2220/58

(57) ABSTRACT

The invention relates to a stationary phase medium for adsorption chromatography, which is in form of porous microspheres suitable for being packed into a chromatographic column. The porous microspheres are made of cross-linked polymeric material and formed with interconnected macropores to constitute a porous network. The invented porous microspheres have a characteristic size ratio of porous network diameter to microsphere particle size, and the porous network is in fluid communication with the ambient via multiple openings, so that molecules are convectively transported through the porous network. Accordingly, the invention shows low back pressure and high binding capacity to molecules at high mobile phase velocities.

### CROSS REFERENCE TO RELATED APPLICATIONS

This application claims priority to U.S. Provisional Application No. 63/392,939 filed Jul. 28, 2022, entitled “POROUS MICROSPHERES AND FILTRATION DEVICE COMPRISING SAME”, and R.O.C. Patent Application No. 112,119,389 filed May 24, 2023, entitled “POROUS MICROSPHERES AND STATIONARY PHASE MEDIUM AND CHROMATOGRAPHIC COLUMN COMPRISING SAME”, both of which are hereby incorporated by reference in their entirety.

### BACKGROUND OF THE INVENTION

### Field of the Invention

The present invention relates to a stationary phase medium for adsorption chromatography and, more particularly, relates to a stationary phase medium fabricated in form of polymeric porous microspheres and adapted for being packed into a chromatographic column for separating molecules with high throughput, with high efficiency and with low back pressure.

### Description of Related Art

In recent years, the global pandemic of coronavirus Covid-19 has led to a sharp increase in demand for the use of adsorption chromatography to purify biomolecules in the development and production of vaccines. Adsorption chromatography is a type of fluid chromatography for separation of a component in a mixture by selective adsorption from a mobile phase onto a solid stationary phase. Porous resin beads have been widely used as the stationary phase for adsorption chromatography. Typical resin beads are formed with a network of tortuous micropores having diameters from several to tens of nanometers, thus allowing low molecular weight solutes present in the mobile phase to diffuse in and out of the micropores. As shown in FIG. 1, the micropores normally reside near the outer surfaces of the resin beads and are not interconnected. Most of the adsorbing surfaces are internal to the resin beads and can only be reached via diffusion. While being proved to be very useful in separating small molecules, the conventional resin beads are shown to perform poorly for separation of macromolecules, as small sizes of the micropores exclude the entry of large molecules. That is to say, macromolecules can only bind to the surfaces of the resin beads, consequently resulting in a low binding capacity. The slow separation speeds are particularly harmful to the biomolecules that are sensitive to enzymatic degradation or other damaging conditions. The resin-based chromatography has additional drawbacks of decrease in the resolution with increase in flow rate because intra-bead diffusion is the rate determining step in the adsorption process and high pressure drop across the chromatographic column due to the limited convective flow between the resin beads. All of these drawbacks result in reduced separation efficiency and unsatisfactory productivity of desired macromolecules. Generally, chromatographic processes which use the conventional resin beads as stational phase media need days to complete and, thus, are extremely time-consuming and cost-ineffective.

FIG. 2 illustrates a conventional adsorption chromatographic column, which includes a hollow elongated tube with covers at the top and bottom openings, allowing a liquid mobile phase to flow through the column from top to bottom. The interior of the column is packed with porous material, which may be in form of block-shaped porous monoliths, micro particulates, or microspheres. The porous material packed inside the column may exhibit adsorption effect on one or more substances, with a maximum binding capacity. Once the binding capacity reaches saturation, no further adsorption is possible. The amount of a specific sample (mg) that can be taken up by the porous material per unit volume (mL) of the porous material is referred to as the binding capacity (expressed in mg/mL). To measure the binding capacity, a mobile phase containing the specific sample is typically loaded through the top opening of the column and allowed to flow through the column, allowing the sample to be adsorbed by the surface functionality of the porous material. The flow-through mobile phase exiting from the bottom of the column is monitored using a UV detector. Initially, the flow-through mobile phase will exhibit low UV absorbance at the bottom outlet, corresponding to a low sample concentration. When the binding capacity reaches its maximum limit, an increase in the UV absorbance of the sample is observed, indicating that the porous material packed inside the column has reached its maximum binding capacity, leading to an increase in the sample concentration in the mobile phase at the outlet. Once the binding capacity reaches its maximum limit, the UV absorbance of the sample will eventually reach its maximum (QB100). By analyzing the rising curve of the absorbance, the amount of the sample loaded at which the UV absorbance at the outlet reaches 10% of its maximum value (QB10) is referred to as the dynamic binding capacity (DBC, expressed in mg/mL). The liquid mobile phase flows through the column at a fixed or variable flow rate (v, usually expressed in cm/h), and the pressure difference generated between the top and bottom openings of the column during the flowing is called back pressure (Δp, usually expressed in MPa).

There are two important requirements in the application of chromatographic purification. Firstly, it is required that the back pressure generated during the purification process is sufficiently low, or alternatively that the mechanical strength of the material packed in the column is sufficiently high to withstand high back pressure. A low back pressure helps avoid exceeding the pressure limits of the chromatographic column and the material packed therewithin, thereby improving the working flow rate and enhancing the purification efficiency. Secondly, it is desired that the dynamic binding capacity (DBC) of the material packed within the chromatographic column does not decrease considerably during the purification as the flow rate of the mobile phase increases. That is to say, the DBC can be maintained while increasing the flow rate, thus allowing for high throughput without compromising the binding capacity.

Efforts have been made in the art to address the requirements above. FIG. 3A shows the back pressure profiles of two representative conventional anion exchange columns CIMmultus™ QA column (purchased from BIA Separations, Slovenia) is filled with poly(methyl methacrylate)-based monolithic material with a pore size of 2 microns, whereas Capto™ Q column (purchased from Danaher Corporation, USA) is packed with porous agarose beads which are formed on outer surfaces with non-interconnected diffusive micropores, each having a diameter of approximately 20-50 nanometers and a single opening to the ambient. FIG. 3A demonstrates that CIMmultus™ QA column filled with block-shaped monolithic material (denoted by the symbol ♦) generates significant back pressure as the mobile phase passes through the column, and the back pressure linearly increases with the flow rate (with a slope of 1.27×10⁻³ MPa hr cm⁻¹). This is disadvantageous for operation stability. On the other hand, Capto™ Q column packed with porous agarose beads (denoted by the symbol ▴) exhibits a slower increase in back pressure with increasing flow rate (with a slope of 8.3×10⁻⁵ MPa hr cm⁻¹), indicative of better operation stability. However, the porous agarose beads are limited by their poor mechanical strength and tend to undergo structural deformation and pore collapse under increased pressure, resulting in a problem of column blockage. As shown in FIG. 3A, when the flow rate exceeds 500 cm/hr, the back pressure of Capto™ Q column rapidly increases, significantly limiting its usage and efficiency (please refer to, for example, Nweke, M. C. et al., Mechanical characterisation of agarose-based chromatography resins for biopharmaceutical manufacture, J. Chromatogr. A, (2017), 1530: 129-137). Since these conventional chromatographic columns tend to suffer from irreversible damages caused by the increased back pressure, their product instructions recommend operating at flow rates below the highest recommended value (600 cm/hr).

FIG. 3B shows the dynamic binding capacity (DBC) of the aforementioned two representative conventional anion exchange columns for molecular separation, with thyroglobulin (TGY) serving as the reference molecule. Regarding Capto™ Q column packed with porous agarose beads (denoted by the symbol ▴), when a mobile phase containing TGY flows through the beads in the column, the mass transfer of TGY primarily occurs through diffusion. In other words, TGY diffuses into the micro-porous structures of the beads from the surfaces of the beads, where it gets adsorbed. However, since TGY has a larger molecular size compared to the diameters of the diffusive pores formed on the bead surfaces, its diffusion into the micro-porous structures is considerably hindered (resulting in a DBC for TGY of 1-2 mg/mL). Therefore, columns of this type are not suitable for purification of biomolecules. On the other hand, regarding CIMmultus™ QA column packed with block-shaped monolithic material (denoted by the symbol ♦), it has relatively large internal pores (approximately 2 microns in diameter). Owing to the monolithic interior structure of the column which allows the mobile phase flows entirely therewithin, TGY is transported by convection and directly adsorbed onto the internal surface of the monolith. This direct contact with the internal surface of the monolithic structure makes the adsorption of molecules more efficient compared to diffusion, resulting in a significantly higher binding capacity for molecules than the bead-type columns (with a DBC for TGY of 22 mg/mL).

Therefore, there is still a need in the art for a stationary phase medium which is fabricated in form of polymeric porous microspheres suitable for being packed into a chromatographic column and exhibits low back pressure and/or high resistance to structural damages at high operational flow rates, without compromising its DBC for molecules as the flow rate is elevated.

### SUMMARY OF THE INVENTION

In order to overcome the drawbacks described above, the invention provides a stationary phase medium for adsorption chromatography, which is in form of a population of porous microspheres suitable for being packed into a chromatographic column. The respective porous microspheres may be made of cross-linked polymeric material and formed with interconnected macropores to constitute a porous network. The porous network provides an extremely large specific surface area as an adsorbing surface, where molecules can easily approach and adhere. It is more important to note that the porous microspheres herein possess a characteristic ratio of the diameter of the internal porous network to the particle size of the microspheres, and the porous network is in communication with the ambient through multiple openings, such that molecules are transported through the internal porous network via convection. Such architecture may achieve low back pressure at high flow rates of the mobile phase and provide a high binding capacity for molecules that remains constant even with increasing flow rates. The invention overcomes long-standing problems in the related art accordingly.

Therefore, in the first aspect provided herein is a stationary phase medium for adsorption chromatography, which is particularly suitable for separation of molecules. The stationary phase medium comprises:

a plurality of porous microspheres, each being formed in its interior with multiple spherical macropores interconnected with one another via interconnecting pores to constitute an open porous network, and formed on its outer surface with multiple openings through which the porous network is in fluid communication with the ambient; and wherein each of the porous microspheres satisfies the following Inequality (1):

dₚₒᵣₑ/d_{microsphere}≥(0.45/n) (1)

where dₚₒᵣₑ represents an equivalent diameter of the porous network, d_{microsphere} represents a diameter of the porous microsphere, and n represents the number of the openings on the microsphere's outer surface through which the porous network is in fluid communication with the ambient, with n being an integer and n≥2.

In the second aspect provided herein is a method for producing the stationary phase medium above, which comprises the steps of:
A) in the presence of a polymerization initiator and an emulsion stabilizer, emulsifying a continuous phase composition comprising at least one monomer and a crosslinking agent with a dispersed phase composition comprising a solvent to obtain a first emulsion comprising a continuous phase and a dispersed phase dispersed in the continuous phase;
B) mixing the first emulsion with a third phase that is immiscible with the first emulsion by applying shear force using a shear device to form a first macro-drop emulsion dispersed in the third phase, and then micronizing the first macro-drop emulsion with a droplet generating device to disperse the first macro-drop emulsion uniformly in the third phase, thereby obtaining a second emulsion containing the third phase and a plurality of monodisperse, high internal phase emulsion droplets dispersed in the third phase; and
C) curing the continuous phase and removing the dispersed phase and the third phase to obtain the stationary phase medium in form of porous microspheres.

In a preferred embodiment, the porous microspheres have a dₚₒᵣₑ of greater than 150 nm. In a more preferred embodiment, the porous microspheres have a dₚₒᵣₑ of greater than 300 nm. In a yet more preferred embodiment, the porous microspheres have a dₚₒᵣₑ of greater than 500 nm.

In a preferred embodiment, the porous microspheres have a d_{microsphere} of less than 500 μm. In a more preferred embodiment, the porous microspheres have a d_{microsphere} of less than 300 μm. In a yet more preferred embodiment, the porous microspheres have a d_{microsphere} of less than 200 μm.

In a preferred embodiment, the stationary phase medium is surface modified with functional groups with or without precoating of a hydrophilic layer to reduce non-specific interference in chromatography. These surface function groups include but are not limited to ion exchange functionality, hydrophobic groups, mixed mode groups, reactive groups, affinity ligands, and combinations thereof.

In preferred embodiments, the porous microspheres are made of cross-linked polymeric material. In more preferred embodiments, the cross-linked polymeric material is selected from the group consisting of polyacrylates, polymethacrylates, polyacrylamides, polystyrenes, polypyrroles, polyethylenes, polypropylenes, polyvinyl chloride and silicones. In yet more preferred embodiments, the cross-linked polymeric material is selected from polymethacrylates.

In more preferred embodiments, the porous microspheres are of monodispersity and have a porosity ranging from 70% to 90%.

In the third aspect provided herein is a stationary phase medium produced by the method above.

In the fourth aspect provided herein is a chromatographic column which comprises a hollow elongated tubular body packed with the stationary phase medium described above.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic view of a resin bead known in the art;

FIG. 2 is a schematic view of a conventional adsorption chromatographic column;

FIG. 3A shows the back pressure profiles of two representative conventional anion exchange columns at different linear flow velocities; and FIG. 3B shows the dynamic binding capacity profiles of two representative conventional anion exchange columns at different linear flow velocities;

FIG. 4 is a schematic view of an adsorption chromatographic column according to one embodiment of the invention;

FIGS. 5A-5C are scanning electron microscopic images of the porous microspheres according to one embodiment of the invention;

FIG. 6 is a schematic diagram showing the mass transfer through the porous microsphere according to one embodiment of the invention;

FIG. 7 shows the flowchart of the method for producing the porous microspheres according to the invention;

FIG. 8 shows the dynamic binding capacity profiles of the anion exchange columns according to some embodiments of the invention at different linear flow velocities; and

FIG. 9 shows the back pressure profiles of the anion exchange columns according to some embodiments of the invention at different linear flow velocities.

### DETAILED DESCRIPTION OF THE PREFERRED EMBODIMENTS

Unless specified otherwise, the following terms as used in the specification and appended claims are given the following definitions. It should be noted that the indefinite article “a” or “an” as used in the specification and claims is intended to mean one or more than one, such as “at least one,” “at least two,” or “at least three,” and does not merely refer to a singular one. In addition, the terms “comprising/comprises,” “including/includes” and “having/has” as used in the claims are open languages and do not exclude unrecited elements. The term “or” generally covers “and/or”, unless otherwise specified. The terms “about” and “substantially” used throughout the specification and appended claims are used to describe and account for small fluctuations or slight changes that do not materially affect the nature of the invention.

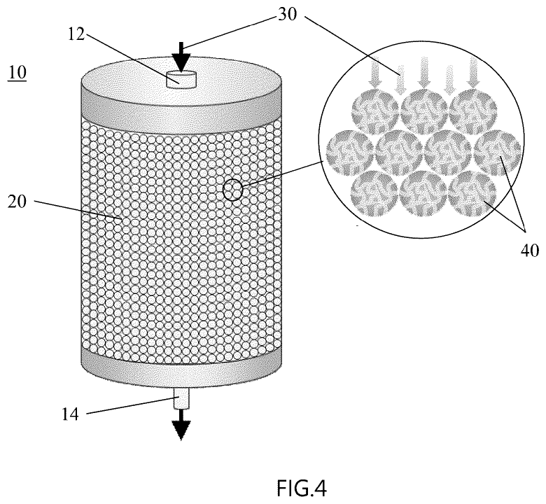

FIG. 4 shows an adsorption chromatographic column 10 according to one embodiment of the invention, which comprises a hollow elongated tubular body equipped with at least one fluid inlet port 12 and at least one fluid outlet port 14. In one embodiment, the tubular body is made of material selected from the group consisting of stainless steel, titan, quartz, glass and rigid plastics, such as polypropylene, and configured in form of a cylindrical, rectangular or polygonal tube. The column 10 is packed with a solid stationary phase 20. As a fluid mobile phase 30 passes through the column 10, molecules contained in the mobile phase 30 are separated due to their differences in adsorptive interaction with the stationary phase 20. The adsorption chromatography may be of the type known in the art, which includes, but is not limited to, ion-exchange chromatography, hydrophobic interaction chromatography, affinity chromatography and reversed-phase chromatography. The fluid mobile phase 30 may be selected from a liquid or a gas. The term “stationary phase” as used herein may refer to an immobilized solid phase carrier through which the mobile phase 30 is allowed to flow through during the chromatography process, such that molecules may be retained by the stationary phase 20. Herein, the stationary phase 20 comprises a population of porous microspheres packed within a chromatographic column 10. The term “stationary phase medium” as used herein intends to encompass the population of porous microspheres in their packed or unpacked state. The mobile phase 30 is applied to the top of the column 10 and allowed to flow downwards to the bottom of the column 10. As shown in FIG. 4, the molecules that are more attracted to the stationary phase 20 are retained in the column 10 for a longer time, whereas the molecules that are less attracted to the stationary phase 20 tend to leave the column 10 from the bottom faster. As a result, molecules with different adsorptive characteristics can be harvested separately. The adsorption chromatography herein may be carried out in either a bind-and-elute mode, in which target molecules are retained on the stationary phase medium and subsequently eluted with a proper eluent, or a flow-through mode where the unwanted molecules and impurities are adsorbed by the stationary phase medium to allow the target molecules to flow through.

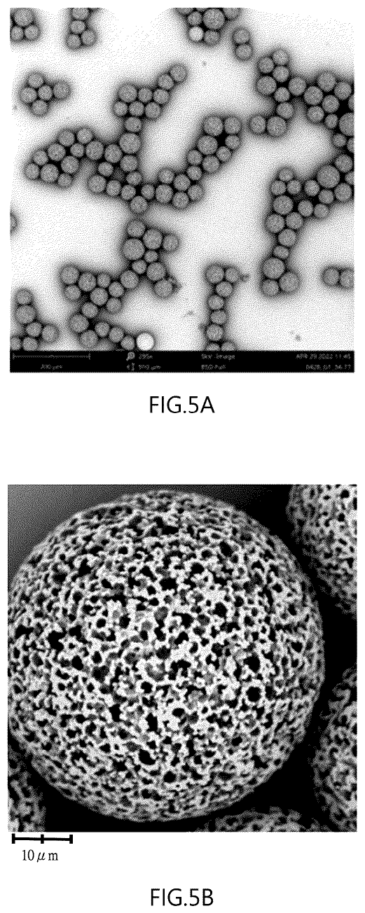

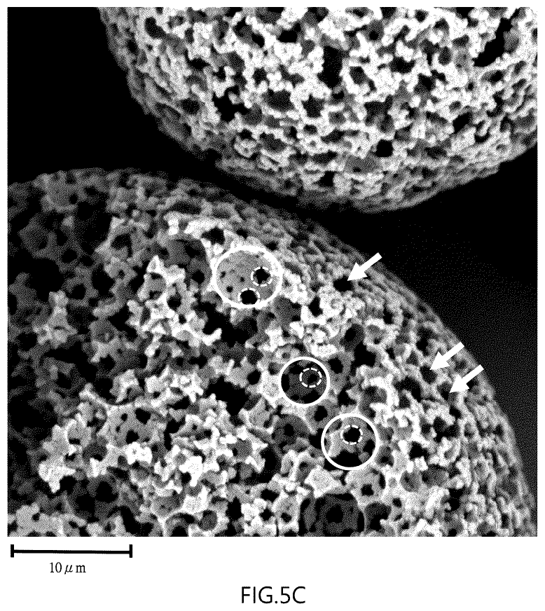

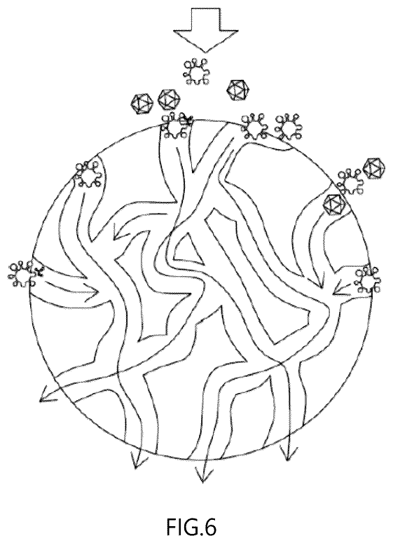

FIGS. 5A-5C show electron microscopic images of the porous microspheres according to the invention. It can be seen clearly that these porous microspheres are substantially spherical in shape. These porous microspheres may be manufactured with a substantially uniform particle size by controlling the manufacturing parameters to achieve monodispersity (namely, a narrow size distribution), and the median diameter of the distribution is referred to as dmicrosphere hereafter. The size distribution of the porous microspheres may be measured using conventional laser scattering or diffraction techniques, such as using a laser diffraction particle size analyzer to measure the scattered laser light from microspheres suspended in a liquid phase. The respective porous microspheres are formed in their interiors with multiple spherical macropores stacked one another, as indicated by the solid circles in FIG. 5C. These macropores are interconnected and in fluid communication with one another via interconnecting pores which are indicated by the dotted circles in FIG. 5C. In an individual porous microsphere, the interconnected macropores, the interconnecting pores associated therewith, and the openings located on the surface of the microsphere (as indicated by the arrows in FIG. 5C) collectively constitute a continuous porous network. The porous network is open to and in fluid communication with the ambient through these openings. In other words, the porous network is in communication with the ambient through n number of openings, where n≥2, so that the porous microsphere allows molecules to enter its interior through one opening and exit through another opening, as illustrated in FIG. 6. The equivalent diameter of this porous network, referred to as dpore hereafter, may be determined by common techniques, such as mercury intrusion porosimetry, capillary flow porometry, and electron microscopy. As stated below, the size of the porous microspheres, as well as the diameter of the porous network, can be adjusted by controlling the parameters and conditions of the process for manufacturing the porous microspheres.

Due to the monodisperse nature of the porous microspheres, when they are packed within a chromatographic column, they tend to stack in a closest-packing arrangement, where adjacent microspheres are arranged tangent to one another and the centers of any three mutually tangent microspheres form an equilateral triangle, while each microsphere has a coordination number of 12 and there leaves triangular voids among the microspheres. Preferably at least 50%, more preferably at least 60%, such as at least 75%, of the porous microspheres packed in the chromatographic column are in a close-packing arrangement, which includes but is not limited to a hexagonal closest packing (hcp) arrangement, a face centered cubic packing (fcc) arrangement, or a combined arrangement thereof. A packed bed composed of closest-packed microspheres creates a pore system comprising voids generated due to the stacking of microspheres and three-dimensional porous networks formed inside the respective microspheres. In this context, the diameter of the voids is referred to herein as d_{void}, and the relationship between d_{void} and the diameter of the microspheres (d_{microsphere}) can be described by the following equation:

d_{void}=0.225×d_{microsphere} (2)

Therefore, d_{void} can be expressed in terms of d_{microsphere}. On the other hand, according to Washburn's equation:

Pd=−4y cosθ (3)

where P=pressure; d=pore diameter; y=surface tension; θ=contact angle. In the case where the mobile phase and the type of the porous microspheres are kept unchanged, γ and θ are constants. In this case, d is inversely proportional to P, where d is contributed by both dₚₒᵣₑ and d_{microsphere}. This suggests that an increase in either the particle size of the porous microspheres packed in the column (d_{microsphere}), or the equivalent diameter of the porous networks (dₚₒᵣₑ), would result in a reduction of back pressure generated by the porous microspheres in the column. The porous microspheres herein are tailored to have a characteristic size ratio of dₚₒᵣₑ to d_{microsphere}, such that they can achieve a low back pressure under high flow rates of the mobile phase and a high binding capacity for large biomolecules, without compromising the same at increased flow rates.

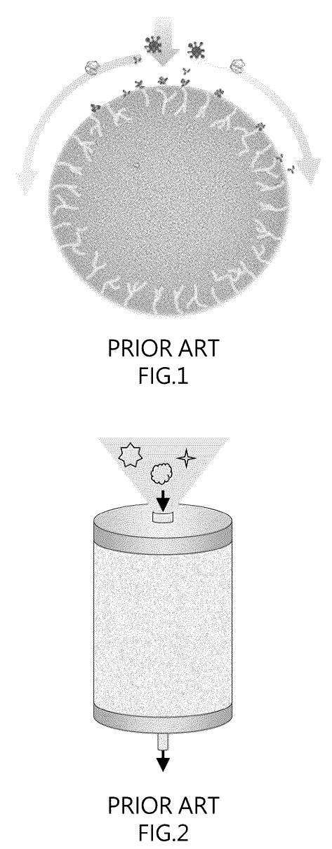

The mass transfer mechanisms in a packed bed may generally be classified into two categories: diffusion and convection. Referring back to FIG. 1, when the pore sizes of the porous microspheres are too small or not interconnected, the mobile phase will only flow around the outer surfaces of the microspheres, and substances contained in the mobile phase can only get into the interiors of the microspheres through diffusion. As the flow rate of the mobile phase increases, it becomes more difficult for the substances to diffuse into the interiors of the porous microspheres, resulting in a decrease in the effective surface area of the microspheres accessible to the substances and thus a decrease in the overall binding capacity. In contrast, when the pore sizes of the porous microspheres are sufficiently large and interconnected, the mobile phase tends to flow through the microspheres by convection, allowing substances to directly enter the interiors of the microspheres, leading to an excellent binding efficiency. As shown in FIG. 6, in the chromatographic column packed with the porous microspheres herein, the mobile phase will flow through the voids between the microspheres and the three-dimensional porous networks formed inside the microspheres.

According to Darcy's law, which is used to describe the flow of a liquid through a porous medium:

$$\frac{Q}{A} = \frac{k}{η} \frac{Δ p}{Δ L} \qquad ( 4 )$$

where η represents the viscosity of the mobile phase, Δp represents the pressure drop, Q represents the flow rate, A represents the cross-sectional area of the flow channel, and AT, is the length of the flow channel. In the case where the column, the packing material and the mobile phase are kept unchanged, the cross-sectional area of the flow channel (A) is directly proportional to the flow rate (Q). Assuming that the pores of the porous medium are circular in shape, then A=πr². Based on the definition of dₚₒᵣₑ provided above, it gives r∝0.5dₚₒᵣₑ. As such, the flow rate is directly proportional to dₚₒᵣₑ. In the case of the invention, where the mobile phase flows through a column packed with porous microspheres, the total flow rate (Qₜₒₜₐₗ) is the sum of the flow through the voids between the microspheres and the flow through the internal porous networks of the microspheres, that is, Qₜₒₜₐₗ=Q_{void}+Qₚₒᵣₑ, and the flow rate is proportional to the pore size. Furthermore, according to Equation (2) above, i.e., d_{void}=0.225×d_{microsphere}, when the size ratio dₚₒᵣₑ/d_{microsphere} decreases, Q_{void} will increase, causing mass transfer to occur primarily through diffusion. In this case, with an increase in the flow rate of the mobile phase, the binding capacity of the porous microspheres will decrease. On the contrary, when the size ratio dₚₒᵣₑ/d_{microsphere} increases, Qₚₒᵣₑ will increase, causing mass transfer to occur primarily through convection. In this case, with an increase in the flow rate of the mobile phase, the binding capacity of the porous microspheres will not significantly decrease. As described above, the porous network of an individual microsphere herein is in communication with the ambient through n number of openings, where n is an integer and n≥2. In other words, n is the number of openings on the microsphere's outer surface which are in communication with the porous network. The number of openings can be calculated through scanning electron microscopy imaging of the respective porous microspheres. As such, assuming that there are n/2 openings facing towards the direction of the incoming flow of the mobile phase and the other n/2 openings are located in the direction of the outgoing flow of the mobile phase, then (n/2) dₚₒᵣₑ≥d_{void}, which may be in turn expressed as dₚₒᵣₑ≥(0.45/n) d_{microsphere}. This inequality can be rewritten in terms of the size ratio dₚₒᵣₑ/d_{microsphere} as follows:

dₚₒᵣₑ/d_{microsphere}≥(0.45/n) (1)

The porous microspheres herein satisfy Inequality (1), thereby facilitating the mobile phase to flow through the internal porous networks of the microspheres via convection and reducing the flow through the voids between the microspheres. This characteristic leads to low back pressure at high flow rates and ensures high and stable binding capacity.

In preferred embodiments, the porous microspheres herein may have a dₚₒᵣₑ of greater than 150 nm, and preferably greater than 300 nm, such as greater than 500 nm. In preferred embodiments, the porous microspheres herein may have a d_{microsphere} of less than 500 μm, and preferably less than 300 μm, such as less than 200 μm, in a bid to reduce the value of d_{void}.

The microspheres disclosed herein are highly porous and the macropores are distributed evenly in the respective microspheres. The porosity of a porous microsphere is defined herein as a percentage of the pore volume relative to the total volume of the microsphere, which may be calculated with the following formula:

1−[(weight of the porous microsphere/density of the continuous phase)/apparent volume of the porous microsphere]

Alternatively, porosity may be determined by taking cross-sectional images of the porous microspheres using a scanning electron microscope, and then calculating the porosity using ImageJ software (National Institutes of Health, Bethesda, Maryland, USA). In one embodiment, the microspheres have a porosity of greater than 50%, such as greater than 70%. However, the porosity does not exceed 90%, so as to maintain the mechanical strength of the microspheres.

The porous microspheres herein may be made of cross-linked polymeric material. The polymeric material useful in the invention includes, but is not limited to, polyacrylates, polymethacrylates, polyacrylamides, polystyrenes, polypyrroles, polyethylenes, polypropylenes, polyvinyl chloride and silicones. In a preferred embodiment, the porous microspheres are made of polymethacrylates.

With fast kinetics, high porosity, good mechanical property and low back pressure, the stationary phase medium herein is useful for separating molecules with large sizes, including those with sizes of more than 15 nm, which include, but are not limited to, proteins (such as thyroglobulin with a size of approximately 17 nm), nucleic acids (mRNA with a size of 100 nm; DNA plasmids with a size of 80-200 nm), viroids, viruses (such as adeno-associated virus, or AAV, with a size of 20 nm; lentivirus with a size of 80-100 nm), viral vectors, virus-like particles (VLPs), extracellular vesicles (EVs) (such as exosomes with a size of 30-100 nm), and liposomes.

In some embodiments, the stationary phase medium is chemically modified to include functional groups for adsorption of molecules with or without precoating of a hydrophilic layer to reduce non-specific interference in chromatography. The precoating of a hydrophilic layer may include, but be not limited to, grafting or coating of non-ionic hydrophilic polymers containing ethylene glycol moieties, and polysaccharides. The surface function groups may include, but be not limited to, ion exchange functionality, hydrophobic groups, mixed mode groups, reactive groups, affinity ligands, and combinations thereof. For example, in the embodiment where the stationary phase medium is used as an ion exchanger, the porous microspheres, including the porous networks formed therein, are surface modified with ion exchange functional groups, such as quaternary amine as a strong anion exchanger, diethylaminoethyl (DEAE) as a weak anion exchanger, sulfonyl as a strong cation exchanger and carboxymethyl as a weak cation exchanger. In an alternative embodiment, the surface functional groups comprise a hydrophobic group selected from the group consisting of an alkyl, preferably a C₄-C₁₈ alkyl, and an aryl. In another alternative embodiment, the surface functional groups comprise a reactive group selected from the group consisting of epoxy, aldehyde and succinimide ester groups (particularly, N-hydroxysuccinimide). In still another alternative embodiment, the surface functional groups comprise a mixed mode group which comprises a hydrophobic group selected from the group consisting of an alkyl and an aryl and an ionic group selected from the group consisting of a quaternary amine, diethylaminoethyl, sulfonyl and carboxymethyl. In still another alternative embodiment, the surface functional groups comprise an affinity ligand specific to certain biomolecules, such as Protein A, Protein G, Oligo dT, and affinity ligands specific to AAVs, lentivirus and exosomes.

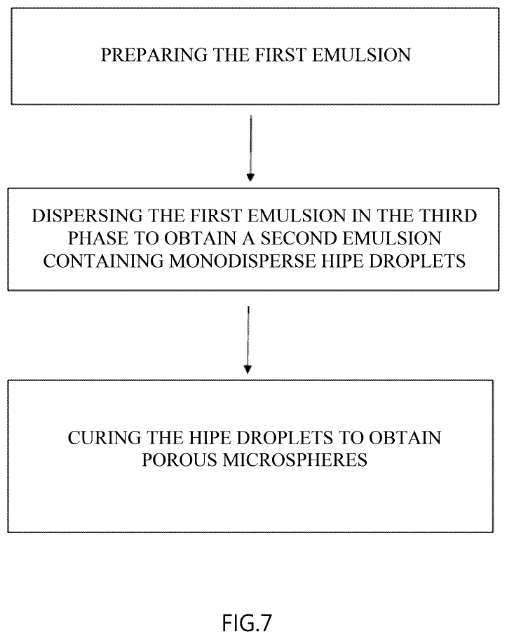

The fabrication of the stationary phase medium herein involves emulsifying two immiscible phases to obtain a first emulsion, dispersing the first emulsion in a third phase by, for example, passing the first emulsion through a perforated sieve plate to obtain uniformly sized, spherical-shaped, high internal phase emulsion (HIPE) droplets suspended in the third phase, and then curing the emulsion droplets to produce the stationary phase medium in form of porous microspheres. FIG. 7 shows the flowchart of the method for producing the stationary phase medium according to the invention, which comprises Step A: preparing the first emulsion; Step B: dispersing the first emulsion in the third phase to obtain a second emulsion containing monodisperse HIPE droplets; and Step C: curing the HIPE droplets to obtain porous microspheres.

Step A involves preparing the first emulsion. The term “emulsion” is used herein to refer to a mixture of a continuous phase (i.e., an external phase) and a dispersed phase (i.e., an internal phase) immiscible with the continuous phase. As used herein, the term “continuous phase” may refer to a phase constituted by a single composition which is contiguous throughout the emulsion. The term “dispersed phase” may refer to a phase constituted by mutually separated units of a composition dispersed in the continuous phase, with each and every unit in the dispersed phase being surrounded by the continuous phase. According to the invention, the continuous phase is usually the one in which polymerization occurs and may comprise at least one monomer, a crosslinking agent, and optionally an initiator and an emulsion stabilizer, whereas the dispersed phase may comprise a solvent and an electrolyte. In preferred embodiments, the first emulsion is a water-in-oil emulsion.

The at least one monomer is meant to encompass any monomers and oligomers that are capable of forming a polymer through polymerization. In one preferred embodiment, the at least one monomer comprises at least one ethylenically unsaturated monomer or acetylenically unsaturated monomer suitable for free radical polymerization, namely, organic monomers with carbon-to-carbon double bonds or triple bonds, which include but are not limited to acrylic acids and the esters thereof, such as hydroxyethyl acrylate; methacrylic acids and the esters thereof, such as glycerol methacrylate (GMA), hydroxyethyl methacrylate (HEMA), methyl methacrylate (MMA); acrylamides; methacrylamides; styrene and its derivatives, such as chloromethylstyrene, divinylbenzene (DVB), styrene sulfonate; silanes, such as dichlorodimethylsilane; pyrroles; vinyl pyridine; and combinations thereof.

The term “crosslinking agent” as used therein may refer to a reagent that chemically bridges the polymer chains formed by polymerization of the at least one monomer. In preferred embodiments, the “crosslinking agent” is a crosslinking monomer which can be dissolved along with the at least one monomer in the continuous phase and usually has multiple functional groups to enable the formation of covalent bonds between the polymer chains of the at least one monomer. Suitable crosslinking agents are well known in the art and can be selected depending upon the type of the at least one monomer, which include but are not limited to oil-soluble crosslinking agents, such as ethylene glycol dimethacrylate (EGDMA), polyethylene glycol dimethacrylate (PEGDMA), ethylene glycol diacrylate (EGDA), triethylene glycol diacrylate (TriEGDA), divinylbenzene (DVB); and water-soluble crosslinking agents, such as N,N-diallylacrylamide, N,N′-methylenebisacrylamide (MBAA). As known to those having ordinary skill in the art, the amount of the crosslinking agent used is positively correlated to the mechanical strength of the porous microspheres produced, that is, the higher the degree of crosslinking, the higher the mechanical strength of the porous microspheres. Preferably, the crosslinking agent is present in an amount about 5 to 50% by weight, such as in an amount about 5 to 25% by weight, of the continuous phase.

In addition to the monomer and the crosslinking agent, the continuous phase may optionally comprise other substances to modify the physical and/or chemical properties of the porous microspheres produced. Examples of these substances include, but are not limited to, magnetic metal particles, such as Fe₃O₄ particles; polysaccharides, such as cellulose, dextran, agarose, agar, alginates; inorganic materials, such as silica; and graphene. For example, adding Fe₃O₄ particles may increase the mechanical strength of the porous microspheres and impart the porous microspheres with ferromagnetism.

The term “emulsion stabilizer” as used herein may refer to a surface-active agent suitable for stabilizing a HIPE and preventing the mutually separated units of the dispersed phase of the emulsion from coalescence. The emulsion stabilizer can be added to the continuous phase composition or the dispersed phase composition prior to preparing the emulsion. The emulsion stabilizer suitable for use herein may be a nonionic surfactant, or an anionic or a cationic surfactant. In the embodiment where the emulsion is a water-in-oil emulsion, the emulsion stabilizer preferably has a hydrophilic-lipophilic balance (HLB) of 3 to 14, and more preferably has a HLB of 4 to 6. In preferred embodiments, a non-ionic surfactant is used herein as the emulsion stabilizer, and the useful types thereof include, but are not limited to polyoxyethylated alkylphenols, polyoxyethylated alkanols, polyoxyethylated polypropylene glycols, polyoxyethylated mercaptans, long-chain carboxylic acid esters, alkanolamine condensates, quaternary acetylenic glycols, polyoxyethylene polysiloxanes, N-alkylpyrrolidones, fluorocarbon liquids and alkyl polyglycosides. Specific examples of the emulsion stabilizer include, but are not limited to sorbitan monolaurate (trade name Span®20), sorbitan tristearate (trade name Span®65), sorbitan monooleate (trade name Span®80), glycerol monooleate, polyethylene glycol 200 dioleate, polyoxyethylene-polyoxypropylene block copolymers (such as Pluronic® F-68, Pluronic® F-127, Pluronic® L-121, Pluronic® P-123), castor oil, mono-ricinoleic acid glyceride, distearyl dimethyl ammonium chloride, and dioleyl dimethyl ammonium chloride.

The term “initiator” may refer to a reagent capable of initiating polymerization and/or crosslinking reaction of the at least one monomer and/or the crosslinking agent. Preferably, the initiator used herein is a thermal initiator which is an initiator capable of initiating the polymerization and/or crosslinking reaction upon receiving heat. The initiator can be added to the continuous phase composition or the dispersed phase composition before preparing the HIPE. According to the invention, the initiators which may be added to the continuous phase composition include, but are not limited to azobisisobutyronitrile (AIBN), azobisisoheptonitrile (ABVN), azobisisovaleronitrile, 2,2-bis[4,4-bis(tert-butylperoxy)cyclohexyl]propane, benzyl peroxide (BPO) and lauroyl peroxide (LPO), whereas the initiators which may be added to the dispersed phase composition include, but are not limited to persulfates, such as ammonium persulfate and potassium persulfate. The emulsion herein may further include a photoinitiator which can be activated by ultraviolet light or visible light to initiate the polymerization and/or crosslinking reaction and, alternatively, a suitable photoinitiator may be used to replace the thermal initiator.

The dispersed phase mainly includes a solvent. The solvent can be any liquid that is immiscible with the continuous phase. In the embodiment where the continuous phase is highly hydrophobic, the solvent may include, but be not limited to water, fluorocarbon liquids and other organic solvents that are immiscible with the continuous phase. Preferably, the solvent is water. In this embodiment, the dispersed phase may further include an electrolyte which can substantially dissociate free ions in the solvent and may include salts, acids, and bases that are soluble in the solvent. Preferably, the electrolyte may be an alkali metal sulfate, such as potassium sulfate, or an alkali metal or alkaline-earth metal chloride salt, such as sodium chloride, calcium chloride, and magnesium chloride.

The emulsion may be added with a polymerization promoter. The term “promoter” may refer to a reagent capable of accelerating polymerization and/or crosslinking reaction of the at least one monomer and/or the crosslinking agent. Typical examples of the promoter include, but are not limited to, N,N,N′,N′-tetramethylethylenediamine (TEMED), N,N,N′,N″,N″-pentamethyl diethylene triamine (PMDTA), tris(2-dimethylamino) ethylamine, 1,1,4,7,10,10-hexamethyltriethylenetetramine, 1,4,8,11-tetramethyl-1,4,8,11-tetraazacyclotetradecane, which can promote the initiator, such as ammonium persulfate, to decompose into free radicals, thereby accelerating the polymerization and/or crosslinking reaction. Preferably, the promoter may be added in an amount of 10-100 mole % with respect to the added amount of the initiator.

The process of obtaining the first emulsion through emulsification involves uniformly mixing the at least one monomer with the crosslinking agent to form a continuous phase composition, and uniformly mixing the solvent with the electrolyte to form a dispersed phase composition. Subsequently, the continuous phase composition and the dispersed phase composition are mixed with agitation in a predetermined ratio, such as in a volume ratio of 5:95 to 40:60, so as to make the dispersed phase evenly dispersed in the continuous phase. In one embodiment, the dispersed phase composition may be slowly added dropwise to the continuous phase composition, while being vigorously agitated to form the emulsion. In an alternative and preferred embodiment, an entire batch of the dispersed phase composition is directly added to the continuous phase composition at one time, while being vigorously agitated to form the emulsion. In the preferred embodiment where the dispersed phase composition is added in a single batch, a high-speed homogenizer may be used to vigorously stir and, therefore, apply a high shear force to the emulsion, so that the separated units of the dispersed phase could have a uniform size. As well known in the art, the size and uniformity of the separated units of the dispersed phase may be tuned by adjusting parameters such as the volume fraction of the dispersed phase relative to the continuous phase, the feeding rate of the dispersed phase composition, the type and concentration of the emulsion stabilizer, and the agitation rate and agitation temperature.

In one embodiment, the first emulsion obtained through the emulsification step above is a high internal phase emulsion (HIPE). The term “high internal phase emulsion”, or abbreviated as “HIPE”, is used herein to refer to an emulsion, in which the internal phase has a volume fraction of more than 74.05% (v/v). According to the invention, in Step B, the first emulsion is mixed with the third phase and then passed through a droplet generating device to uniformly disperse the first emulsion in the third phase, resulting in a second emulsion containing monodisperse HIPE droplets dispersed in the third phase.

As used herein, the term “third phase” may refer to a phase in which the HIPE can be stably dispersed and is immiscible with the continuous phase of the HIPE. The third phase primarily comprises a solvent, which may include but be not limited to water, fluorocarbon liquids, and other organic solvents that are immiscible with the continuous phase. Preferably, the solvent is water. In preferred embodiments, the second emulsion is a water-in-oil-in-water emulsion. The third phase may further comprise an electrolyte which can substantially dissociate free ions in the solvent and may include salts, acids, and bases that are soluble in the solvent. Preferably, the electrolyte may be an alkali metal sulfate, such as potassium sulfate, or an alkali metal or alkaline-earth metal chloride salt, such as sodium chloride, calcium chloride, and magnesium chloride. The third phase may further comprise an emulsion stabilizer as defined above.

In preferred embodiments, the first emulsion may be added to the third phase, and the mixture thus obtained may be subjected to shear force generated by a shear device to form a first macro-drop emulsion dispersed in the third phase. The shear device may be selected from a mechanical stirring device or a three-dimensional aperture array. Afterwards, the first macro-drop emulsion is further micronized and uniformly dispersed in the third phase using a droplet generating device to obtain a second emulsion containing the third phase and a plurality of monodisperse, high internal phase emulsion droplets dispersed in the third phase. The droplet generating device is adapted to generate a large number of monodisperse HIPE droplets, which may be a sieve plate perforated with narrow channels (whose configuration is not limited to straight, approximate straight, smooth curve, or approximate smooth curve) or, alternatively, a three-dimensional aperture array. The sieve plate perforated with channels may be made of any inert material that does not undergo physical and chemical reactions with the first emulsion and the second emulsion, and examples of the inert material may include carbon fiber, ceramics, glass, quartz, silicon wafers, plastics, e.g., polyvinyl chloride (PVC), polyoxymethylene (POM), polycarbonate (PC), polyphenylene oxide (PPO), PA6/66 nylon, polycarbonate (PC)/acrylonitrile butadiene styrene (ABS) composites, polyethylene terephthalate (PET), polyetherimide (PEI), polymethyl methacrylate (PMMA), polyphenylene sulfide (PPS), polyethylene (PE), polypropylene (PP), polystyrene (PS) and ethylene vinyl acetate (EVA), and metal material, e.g., stainless steel, Ti, Al and Al-Mg alloys.

The HIPE droplets dispersed in the third phase will spontaneously form into spherical shape due to their inherent cohesive force. The size of the HIPE droplets may be adjusted by selecting the channel size of the droplet generating device.

In Step C, the HIPE droplets may be further subjected to heat, and/or exposed to light with an appropriate wavelength, or added with a polymerization promoter, so as to allow the at least one monomer and/or the crosslinking agent to complete polymerization and/or crosslinking reaction, whereby the HIPE droplets are cured into a shaped mass. The term “cure” or “curing” as used herein may refer to a process of converting the HIPE droplets into a structure with a stable free-standing configuration. The dispersed phase and the third phase are removed afterwards from the cured HIPE droplets, thus forming a stationary phase medium in form of porous microspheres. In the embodiment where the first emulsion is a water-in-oil emulsion, the cured HIPE droplets may be dried directly, preferably dried under vacuum, to thereby facilitate rupturing the mutually separated units of the dispersed phase to generate the interconnecting pores. The size and uniformity of the macropores in the porous microspheres can be adjusted by changing the agitation speed and/or the agitation temperature during the preparation of the first emulsion, whereas the size of the interconnecting pores and, therefore, the equivalent diameter of the porous networks formed in the porous microspheres, can be modified by altering the volume ratio of the dispersed phase to the continuous phase in the emulsion.

In a preferred embodiment, the porous microspheres obtained in step C are sieved through one or more Taylor screens to exclude oversized, undersized, or broken microspheres, and the microspheres within desired size ranges are collected.

Table 1 shows the porous microspheres produced by the manufacturing method above and satisfying Inequality (1), with four different sizes denoted as A, B, C, and D, respectively.

| Mark | dₚₒᵣₑ | d_{microsphere} | dₚₒᵣₑ/d_{microsphere} |
|---|---|---|---|
| A | 1.0 μm | 50 μm | 0.020 |
| B | 1.4 μm | 50 μm | 0.028 |
| C | 1.8 μm | 50 μm | 0.036 |
| D | 2.2 μm | 50 μm | 0.044 |

The porous microspheres A, B, C and D as listed in Table 1 were added into a 1% aqueous solution of tetraethyl pentamine, respectively, and heated at 70° C. for at least 5 hours. The porous microspheres were filtered out and added into a 1% aqueous solution of glycidyltrimethylammonium chloride, respectively, and heated at 70° C. for at least 5 hours. The porous microspheres were washed with water to obtain four types of strong anion exchangers based on porous microspheres A, B, C and D.

1 mL of the strong anion exchangers prepared above were packed into a polypropylene chromatographic column with an internal diameter of 7.4 mm and a height of 3 mm, respectively.

Experimental Results 1: Test for Dynamic Binding Capacity

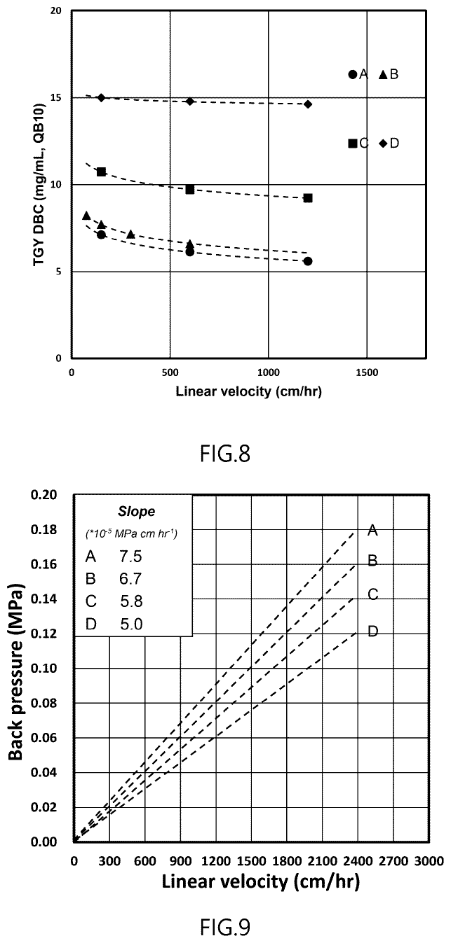

The chromatographic columns packed with porous microspheres A, B, C and D were tested for dynamic binding capacity to thyroglobulin (TGY). The mobile phase used herein was 50 mM Tris-HCl, pH 8.5, with 1 mg/mL TGY being applied to the mobile phase as an analyte. DBC was detected by an AKTA' Pure chromatography system (Cytiva Sweden AB, Uppsala, Sweden). The results are shown in FIG. 8.

It can be observed from FIG. 8 that under the circumstances that the four types of microspheres have substantially the same particle size (d_{microsphere}), microspheres A with the smallest diameter of the porous networks (dₚₒᵣₑ=1.0 μm) exhibited a binding capacity of 5-7 mg/mL, and this binding capacity decreased considerably with increasing flow rates. This indicates that when the size ratio of pore diameter to microsphere diameter (dₚₒᵣₑ/d_{microsphere}) is relatively small, the adsorption of TGY tends to occur via diffusion. As for microspheres B (dₚₒᵣₑ=1.4 μm), C (dₚₒᵣₑ=1.8 μm), and D (dₚₒᵣₑ=2.2 μm) whose porous networks have relatively large diameters, their binding capacities are 6-8 mg/mL, 9-11 mg/mL, and 14-15 mg/mL, respectively, and their binding capacities showed a slower decrease with increasing flow rates and remained stable at higher flow rates. Therefore, by adjusting the size ratio of porous microspheres (dₚₒᵣₑ/d_{microsphere}), the mass transfer mode in a chromatography column can be modified. In other words, increasing the size ratio of dₚₒᵣₑ/d_{microsphere} ensures convective mass transfer of the mobile phase, resulting in less influence of the flow rate on the adsorption behavior.

Experimental Results 2: Back Pressure Test

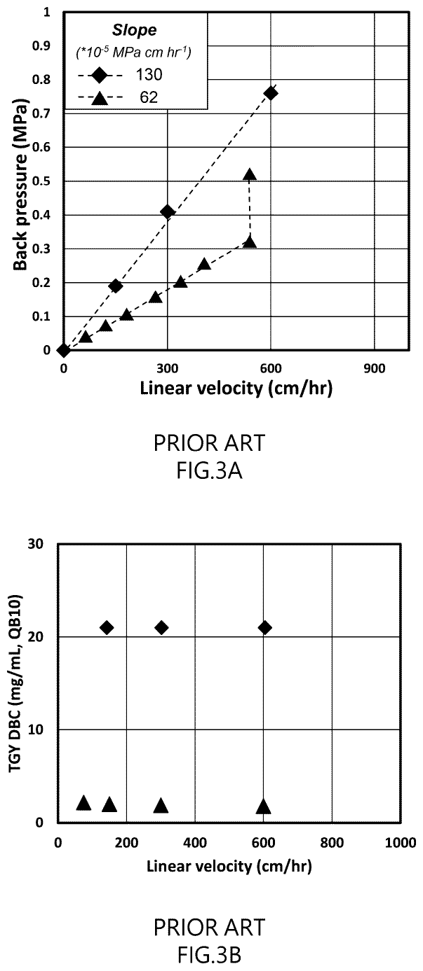

FIG. 9 shows the back pressure profiles of the four chromatographic columns packed with microspheres A, B, C, and D at different linear velocities. The results demonstrate that all four columns exhibited low back pressure under high working flow velocities of the mobile phase. Moreover, the back pressures of these columns at high flow rates (>600 cm/hr) were much lower than those of the conventional columns shown in FIG. 3A at the same flow rates. As shown in Experimental Results 2, even for microspheres A, the slope of back pressure against flow velocity (7.5×10⁻⁵ MPa cm hr⁻¹) was apparently less steep than those observed in the conventional columns (130 and 62×10⁻⁵ MPa cm hr⁻¹, respectively), and such results perfectly evidenced the advantages of the chromatographic columns packed with porous microspheres according to the invention. Therefore, the invention further contemplates a chromatographic column which comprises a hollow tubular body packed with porous microspheres above and equipped with at least one fluid inlet port and at least one fluid outlet port. The columns herein exhibited a slope of fluid back pressure against fluid flow velocity of less than or equal to 50×10⁻⁵ MPa cm hr⁻¹, preferably less than or equal to 30×10⁻⁵ MPa cm hr⁻¹, such as less than or equal to 10×10⁻⁵ MPa cm hr⁻¹.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A stationary phase medium for adsorption chromatography comprising:
a plurality of porous microspheres, each being formed in its interior with multiple spherical macropores interconnected with one another via interconnecting pores to constitute an open porous network, and formed on its outer surface with multiple openings through which the porous network is in fluid communication with the ambient; and
wherein each of the porous microspheres satisfies the following Inequality (1):
dₚₒᵣₑ/d_{microsphere}≥(0.45/n) (1)
where dₚₒᵣₑ represents an equivalent diameter of the porous network, d_{microsphere} represents a diameter of the porous microsphere, and n represents the number of the openings on the microsphere's outer surface through which the porous network is in fluid communication with the ambient, with n being an integer and n≥2.

2. The stationary phase medium of claim 1, wherein the porous microspheres have a dpore of greater than 150 nm.

3. The stationary phase medium of claim 2, wherein the porous microspheres have a dpore of greater than 300 nm.

4. The stationary phase medium of claim 3, wherein the porous microspheres have a dpore of greater than 500 nm.

5. The stationary phase medium of claim 1, wherein the porous microspheres have a dmicrosphere of less than 500 μm.

6. The stationary phase medium of claim 5, wherein the porous microspheres have a dmicrosphere of less than 300 μm.

7. The stationary phase medium of claim 6, wherein the porous microspheres have a dmicrosphere of less than 200 μm.

8. The stationary phase medium of claim 1, wherein the stationary phase medium is surface modified with surface functional groups.

9. The stationary phase medium of claim 8, wherein the stationary phase medium is further precoated with a hydrophilic layer.

10. The stationary phase medium of claim 9, wherein the hydrophilic layer is made of material selected from the group consisting of non-ionic hydrophilic polymers containing ethylene glycol moieties, and polysaccharides.

11. The stationary phase medium of claim 8, wherein the surface functional groups are selected from the group consisting of ionic groups, hydrophobic groups, reactive groups, mixed mode groups, affinity ligands, and combinations thereof.

12. The stationary phase medium of claim 11, wherein the surface functional groups comprise an ionic group selected from the group consisting of a quaternary amine, diethylaminoethyl, sulfonyl and carboxymethyl.

13. The stationary phase medium of claim 11, wherein the surface functional groups comprise a hydrophobic group selected from the group consisting of an alkyl and an aryl.

14. The stationary phase medium of claim 13, wherein the hydrophobic group is selected from a C₄-C₁₈ alkyl.

15. The stationary phase medium of claim 11, wherein the surface functional groups comprise a reactive group selected from the group consisting of epoxy, aldehyde and succinimide ester group.

16. The stationary phase medium of claim 11, wherein the surface functional groups comprise a mixed mode group which comprises a hydrophobic group selected from the group consisting of an alkyl and an aryl and an ionic group selected from the group consisting of a quaternary amine, diethylaminoethyl, sulfonyl and carboxymethyl.

17. The stationary phase medium of claim 11, wherein the surface functional groups comprise an affinity ligand selected from Protein A, Protein G, Oligo dT, and affinity ligands specific to AAVs, lentivirus and exosomes.

18. The stationary phase medium of claim 1, wherein the porous microspheres are made of cross-linked polymeric material.

19. The stationary phase medium of claim 18, wherein the cross-linked polymeric material is selected from the group consisting of polyacrylates, polymethacrylates, polyacrylamides, polystyrenes, polypyrroles, polyethylenes, polypropylenes, polyvinyl chloride and silicones.

20. The stationary phase medium of claim 19, wherein the cross-linked polymeric material is selected from polymethacrylates.

21. The stationary phase medium of claim 20, wherein the porous microspheres are of monodispersity and have a porosity ranging from 70% to 90%.

22. A method for producing the stationary phase medium, comprising the steps of:
A) in the presence of a polymerization initiator and an emulsion stabilizer, emulsifying a continuous phase composition comprising at least one monomer and a crosslinking agent with a dispersed phase composition comprising a solvent to obtain a first emulsion comprising a continuous phase and a dispersed phase dispersed in the continuous phase;
B) mixing the first emulsion with a third phase that is immiscible with the first emulsion by applying shear force using a shear device to form a first macro-drop emulsion dispersed in the third phase, and then micronizing the first macro-drop emulsion with a droplet generating device to disperse the first macro-drop emulsion uniformly in the third phase, thereby obtaining a second emulsion containing the third phase and a plurality of monodisperse, high internal phase emulsion droplets dispersed in the third phase; and
C) curing the continuous phase and removing the dispersed phase and the third phase to obtain the stationary phase medium in form of porous microspheres;
wherein each of the porous microspheres is formed in its interior with multiple spherical macropores interconnected with one another via interconnecting pores to constitute an open porous network, and formed on its outer surface with multiple openings through which the porous network is in fluid communication with the ambient; and
wherein each of the porous microspheres satisfies the following Inequality (1):
dₚₒᵣₑ/d_{microsphere}≥(0.45/n) (1)
where dₚₒᵣₑ represents an equivalent diameter of the porous network, d_{microsphere} represents a diameter of the porous microsphere, and n represents the number of the openings on the microsphere's outer surface through which the porous network is in fluid communication with the ambient, with n being an integer and n≥2.

23. The method of claim 22, wherein the step of forming the first macro-drop emulsion dispersed in the third phase comprises applying shear force with a mechanical stirring device or a three-dimensional aperture array.

24. The method of claim 22, wherein the droplet generating device is selected from a sieve plate perforated with narrow channels and a three-dimensional aperture array.

25. The method of claim 22, further comprising a step D, subsequent to the step C, of sieving the porous microspheres obtained in step C through one or more Taylor screens to exclude oversized, undersized, or broken microspheres.

26. A stationary phase medium for adsorption chromatography produced by the method of claim 22.

27. A chromatographic column, comprising a hollow tubular body packed with a plurality of porous microspheres and equipped with at least one fluid inlet port and at least one fluid outlet port, wherein each of the porous microspheres is formed in its interior with multiple spherical macropores interconnected with one another via interconnecting pores to constitute an open porous network, and formed on its outer surface with multiple openings through which the porous network is in fluid communication with the ambient; and
wherein each of the porous microspheres satisfies the following Inequality (1):
dₚₒᵣₑ/d_{microsphere}≥(0.45/n) (1)
where dₚₒᵣₑ represents an equivalent diameter of the porous network, d_{microsphere} represents a diameter of the porous microsphere, and n represents the number of the openings on the microsphere's outer surface through which the porous network is in fluid communication with the ambient, with n being an integer and n≥2.

28. The chromatographic column of claim 27, which exhibits a slope of fluid back pressure against fluid flow velocity of less than or equal to 50×10⁻⁵ MPa cm hr⁻¹.

29. The chromatographic column of claim 27, which exhibits a slope of fluid back pressure against fluid flow velocity of less than or equal to 30×10⁻⁵ MPa cm hr⁻¹.

30. The chromatographic column of claim 27, which exhibits a slope of fluid back pressure against fluid flow velocity of less than or equal to 10×10⁻⁵ MPa cm hr⁻¹.

31. The chromatographic column of claim 27, wherein at least 50% of the porous microspheres packed in the chromatographic column are in a close-packing arrangement.
